(19) United States
(12) Patent Application Publication
(10) Pub. No.: US 2019/0098873 A1
(43) Pub. Date: Apr. 4, 2019

(54) PET LEASH ASSEMBLY

(71) Applicant: Darrell Kemball BENNETT, Albion (AU)

(72) Inventor: Darrell Kemball BENNETT, Albion (AU)

(21) Appl. No.: 16/131,762

(22) Filed: Sep. 14, 2018

(30) Foreign Application Priority Data
Sep. 15, 2017 (AU) 2017903749

(51) Int. Cl. A01K 27/00; A01K 7/00; A01K 23/00; B65D 43/02; B65D 25/28; B65D 55/16

(52) U.S. Cl. CPC A01K 27/008; A01K 7/00; A01K 23/005; B65D 55/16; B65D 43/0231; B65D 25/2882; A01K 27/003

(57) ABSTRACT

A pet leash assembly, including: a housing configured to provide a handle, an internal cavity, and an opening leading into the internal cavity; a fluid reservoir having a hollow body positioned within the internal cavity of the housing, the fluid reservoir including a fluid inlet arranged to extend at least partially through the opening to enable the body to be filled and/or emptied via the fluid inlet; and a leash coupled to the housing.

### BACKGROUND OF THE INVENTION

The present invention relates to a pet leash assembly, and in one example, to a hand-held dog leash having a multi-function handle providing various accessories for use on walks or while away from home.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The use of pet leashes or leads for restraining a pet such as a dog while out in public spaces or on walks is well known. Some pet leashes have a housing which provides a handle or grip for a user to hold. The leash extends from the housing and typically is retractable allowing the shortening or lengthening of the leash which restricts or increases the range of movement provided to the pet. Such retractable leashes are wound up on a spool mechanism which is provided in the housing.

In addition to holding the leash in one hand, a pet owner will also typically carry a range of accessories and supplies for the pet such as water bottles, disposable waste bags and then used waste bags. Each time the pet is taken on a walk, an owner must remember to bring all of these items which is often onerous and inconvenient.

Whilst a retractable leash has some benefits, the problem of remembering to bring and then having to carry additional items often outweighs these benefits. It would therefore be advantageous to provide an improved pet leash assembly which provides greater convenience to a pet owner or at least a useful alternative.

It is against this background, and the problems and difficulties associated therewith, that the present invention has been developed.

### SUMMARY OF THE PRESENT INVENTION

In one broad form, an aspect of the present inventions seeks to provide a pet leash assembly, including:
a) a housing configured to provide:
   i) a handle;
   ii) an internal cavity; and,
   iii) an opening leading into the internal cavity;
b) a fluid reservoir having a hollow body positioned within the internal cavity of the housing, the fluid reservoir including a fluid inlet arranged to extend at least partially through the opening to enable the body to be filled and/or emptied via the fluid inlet; and,
c) a leash coupled to the housing.

In one embodiment, the body has a height that substantially corresponds to a height of the housing.

In one embodiment, a ratio between a length of the housing and a length of the body is in a range of 3:1 to 1.5:1.

In one embodiment, the body is positioned at least partially in abutment with a leading edge surface of the housing.

In one embodiment, the body includes a curved outer surface portion that substantially conforms to a curvature of the housing.

In one embodiment, the housing further provides a fixed attachment point for the leash.

In one embodiment, the attachment point is located within the internal cavity.

In one embodiment, the attachment point is a protrusion that extends substantially across the housing and wherein the body of the fluid reservoir is shaped to accommodate the positioning of the attachment point within the internal cavity.

In one embodiment, the leash is looped around the attachment point and fed through a leash aperture in the housing.

In one embodiment, the fluid reservoir further includes a cap for covering the fluid inlet, the cap in use disposed above a top surface of the housing.

In one embodiment, the cap is tethered to the housing by a strap.

In one embodiment, the internal cavity includes at least one partition that in use defines an internal storage area between the handle and the fluid reservoir.

In one embodiment, the internal storage area is used for storing pet waste bags.

In one embodiment, the internal storage area is accessible from a bottom surface of the housing.

In one embodiment, the internal storage area is covered by a removable cover that includes an opening through which waste bags can be dispensed.

In one embodiment, the internal storage area is covered by a removable cover and wherein the housing includes a slot in a side portion thereof for dispensing the waste bags.

In one embodiment, the removable cover includes a pair of resiliently deformable wings that releasably latch to the housing.

In one embodiment, a portion of the wings project below the housing and are responsive to a squeezing pressure to unlatch the cover.

In one embodiment, the assembly further includes a hook attached to or integral with the housing for hanging used waste bags.

In one embodiment, the hook is disposed beneath the housing.

In one embodiment, a collapsible bowl is releasably mounted to one side of the housing.

In one embodiment, the housing includes a plurality of resiliently deformable clips that project outward from the side of the housing for releasably securing the collapsible bowl thereto.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:—

FIG. 1A is a schematic upper perspective view of an example of a pet leash assembly;

FIG. 1B is a schematic lower perspective view of the pet leash assembly of FIG. 1A;

FIG. 1C is a schematic side view of the pet leash assembly of FIG. 1A;

FIG. 1D is a schematic cross-sectional view through section A-A of FIG. 1C;

FIG. 2 is a schematic exploded view of the pet leash assembly of FIG. 1A;

FIG. 3A is schematic perspective view of a first housing portion of the pet leash assembly of FIG. 1A;

FIG. 3B is a schematic perspective view of a second housing portion of the pet leash assembly of FIG. 1A;

FIG. 4A is a schematic upper perspective view of the pet leash assembly of FIG. 1A with the second housing portion removed;

FIG. 4B is a schematic side view of the pet leash assembly shown in FIG. 4A;

FIG. 5A is a schematic perspective view of a collapsible bowl in an extended configuration;

FIG. 5B is a schematic perspective view of the collapsible bowl of FIG. 5A in a collapsed configuration; and,

FIG. 6 is a schematic side view of another example of a pet leash assembly having a waste bag dispensing slot located in a side of the housing.

### DETAILED DESCRIPTION OF THE PREFERRED EMBODIMENTS

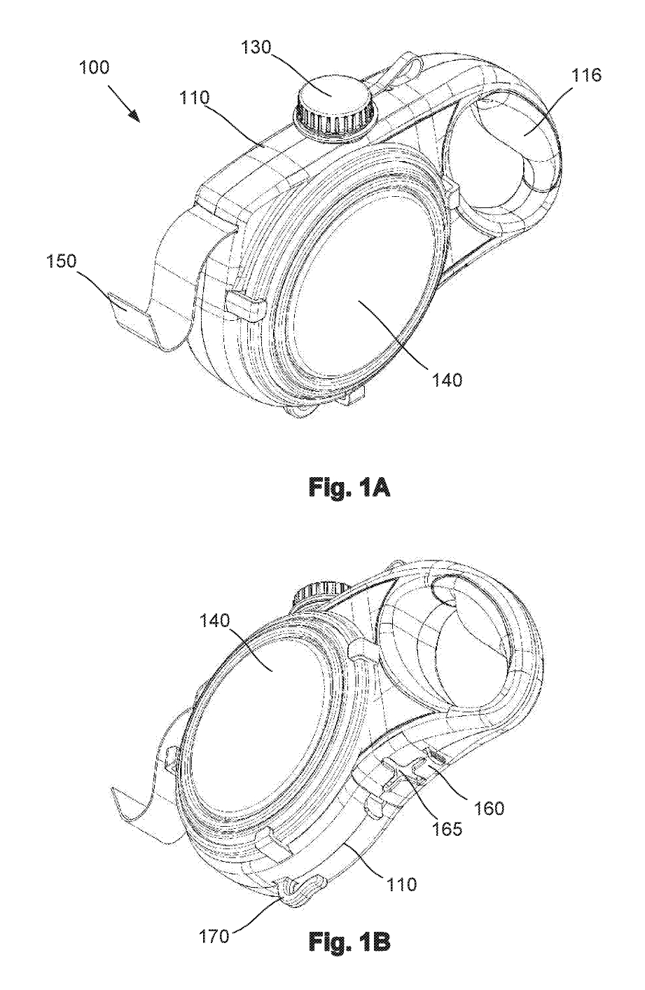

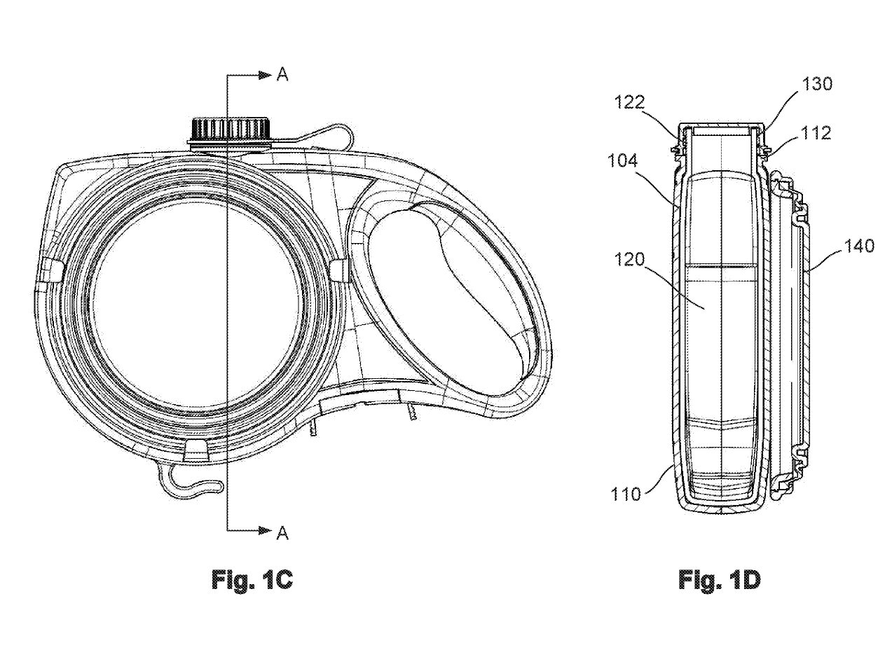

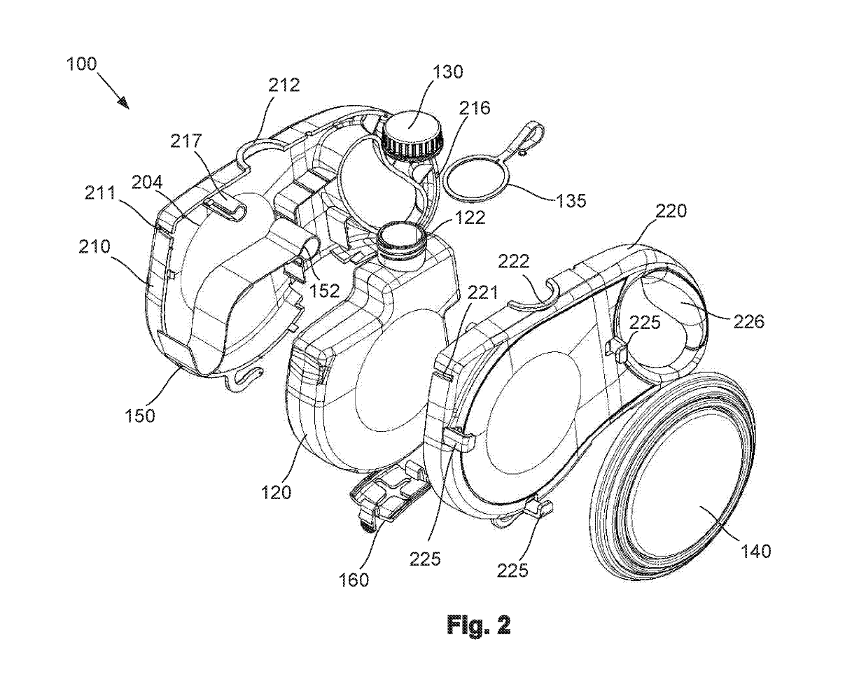

An example of a pet leash assembly 100 will now be described with reference to FIGS. 1A to 1D.

In this example, the assembly 100 includes a housing 110 configured to provide a handle 116 allowing a user to grip the assembly with one hand. The housing 110 further includes an internal cavity 104 (as shown in FIG. 1D) and an opening 112 leading into the internal cavity 104. As shown, the opening 112 is typically positioned on top of the housing 110.

The assembly 100 also includes a fluid reservoir 120 (e.g. bottle) having a hollow body positioned within the internal cavity 104 of the housing 110. The fluid reservoir 120 includes a fluid inlet 122 arranged to extend at least partially through the opening 112 to enable the body to be filled and/or emptied via the fluid inlet 122. It will be appreciated that typically the fluid reservoir would be filled with water, however other fluids may also be used such as medicated fluids containing antibiotics or other medicaments or additives, for example to freshen breath.

A leash or lead 150 is coupled to the housing 110 for attachment to a pet to thereby enable the pet to be restrained in a conventional manner when on a walk.

The above described arrangement provides a number of advantages.

Firstly, it enables a water supply for the pet to be carried in a compact and convenient manner for use when out on a walk. Being able to carry a supply of water avoids the need to find a tap or other source of water when away from home. The pet owner is therefore able to provide a drink of water to the pet whenever needed, which is particularly advantageous on hot days or when out on a long walk. Particular breeds of dog (e.g. bulldogs) prone to overheating can also be provided more regular hydration to maintain optimum health whilst exercising or travelling away from home.

As the fluid inlet 122 of the reservoir 120 extends at least partially through the opening 112 in the housing 110, it will be appreciated that the fluid reservoir 120 is able to be used in situ without requiring any part of the housing to be disassembled. The assembly 100 is therefore simple to use and multi-functional in that it operates as both a leash to restrain the pet and also a bottle for holding a fluid such as water. The assembly 100 not only carries or transports the bottle but effectively acts as a bottle in that fluid is dispensed from the assembly simply by unscrewing or removing a cap or similar cover that covers the inlet. It is further to be appreciated that the above described assembly would have similar dimensions to standard leash assemblies which house retractable leashes.

A number of further features will now be described.

In one example, the body of the fluid reservoir 120 has a height that substantially corresponds to a height of the housing 110. Accordingly, the space provided for by the internal cavity 104 is well utilised and the volume of the fluid reservoir 120 is maximised.

Furthermore, achieving a maximum volume of the fluid reservoir is also assisted by ensuring that a ratio between a length of the housing 110 and a length of the body is in a range of 3:1 to 1.5:1. In other words, the width of the reservoir is between about 33% to 50% of the width of the housing 110. As will be discussed in more detail below, compared to a traditional retractable hand-held leash assembly which houses a spool upon which the lead is wound, the assembly 100 does not have a spool which creates the space necessary to house the fluid reservoir 120. This enables a useful amount of fluid to be stored in the fluid reservoir 120 whilst not substantially increasing the overall size of the housing of the pet leash assembly from that which is already familiar and comfortable to pet owners.

Typically, the body of the fluid reservoir 120 is positioned at least partially in abutment with a leading edge surface of the housing and the body also includes a curved outer surface portion that substantially conforms to a curvature of the housing 110. In this way, at least a part of the fluid reservoir 120 is shaped in conformity with the housing which again promotes most efficient utilisation of available space in the internal cavity 104.

As mentioned above, the leash 150 is not retractable which has enabled a conventional spool mechanism to be removed. Instead of a spool, the housing 110 provides a fixed attachment point for the leash 150. Typically, the attachment point is located within the internal cavity 104 and in one example is a protrusion that extends substantially across the housing 110 and wherein the body of the fluid reservoir 120 is shaped to accommodate the positioning of the attachment point within the internal cavity 104.

Typically, the leash 150 is looped around the attachment point and fed through a leash aperture in the housing 110. A free portion of the leash 150 therefore extends from the housing 110 for attachment to the pet.

In one example, the fluid reservoir 120 further includes a cap 130 for covering the fluid inlet 122, the cap 130 in use disposed above a top surface of the housing 110. The cap 130 is typically tethered to the housing 110 by a strap to ensure that the cap 130 remains attached to the housing 110 when unscrewed so that it is not inadvertently misplaced or lost.

In addition to the fluid reservoir 120, the assembly 100 may also house or permit attachment of further items that may be needed when taking a pet out for a walk. In one example, the internal cavity 104 includes at least one partition that in use defines an internal storage area between the handle 116 and the fluid reservoir 120. Whilst any appropriately sized item may be housed in this storage area, typically the internal storage area is used for storing a roll of pet waste bags. The waste bags may therefore be concealed neatly by the housing 110 which further obviates the need to attach a roll of waste bags to the handle or other external mounting fixture of the leash assembly as has been traditionally done in the past.

As shown for example in FIG. 1B, the internal storage area is accessible from a bottom surface of the housing 110 and typically the internal storage area is covered by a removable cover 160 that includes an opening 165 through which waste bags can be dispensed. In other examples, the removable cover 160 may simply function to allow rolls of waste bags to be loaded into the housing and a separate slot or opening may be provided in the housing through which the bags are dispensed. A slot may for example be provided on one side of the housing 110 as will be described in further detail below.

The removable cover 160 more specifically may include a pair of resiliently deformable wings that releasably latch to the housing 110. A portion of the wings may project below the housing and be responsive to a squeezing pressure to unlatch the cover 160. The cover 160 is therefore able to be removed in a simple and convenient manner without the need for any special tools.

In one example, the assembly 100 further includes a hook 170 attached to or integral with the housing 110 for hanging used waste bags. The use of the hook 170 provides a convenient way for used waste bags to be carried and provides a useful alternative to a user having to carry the bags themselves or tie them to the lead. The hook 170 may be disposed in any usable position, but preferably it is located beneath the housing as shown in FIG. 1B.

The functionality of the pet leash assembly 100 is further enhanced by the provision of a collapsible bowl 140 that is releasably mounted to one side of the housing 110. In this regard, the housing 110 includes a plurality of resiliently deformable clips that project outward from the side of the housing 110 for releasably securing the collapsible bowl 140 thereto. The collapsible bowl may be constructed in any suitable manner which enables it to fold or collapse into a compact configuration for storage when not in use as a drinking or food bowl. The provision of a bowl that is compactly carried with the pet leash assembly 100 enables water from the fluid reservoir 120 to be emptied into the bowl so that the pet can have a drink from a familiar bowl when out on a walk or travelling away from home.

The pet leash assembly 100 will now be described in further detail with reference to FIGS. 2 to 5B.

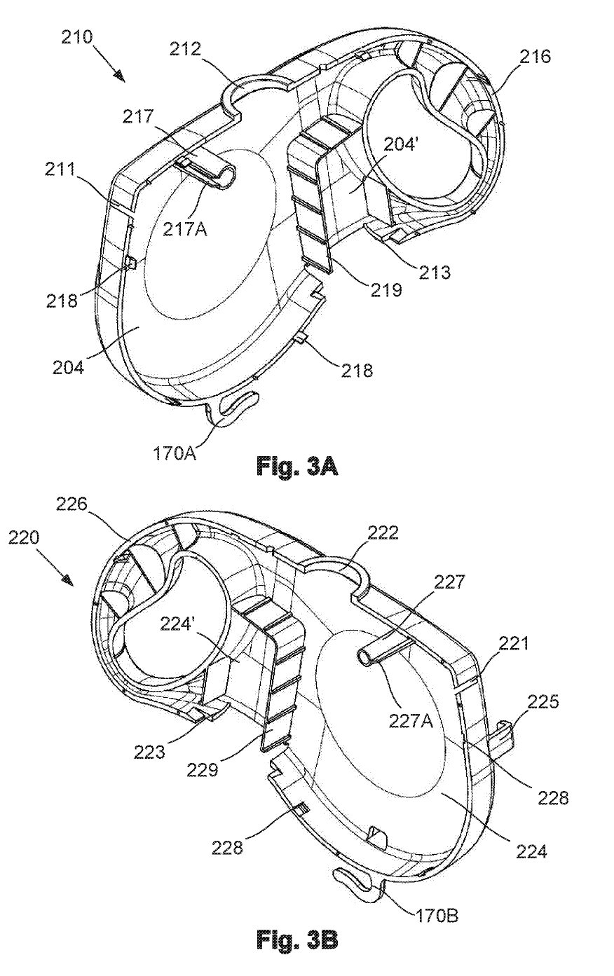

Referring to FIG. 2, there is shown an exploded view of the pet least assembly 100. In this view, it can be seen that the housing 110 is comprised of first and second moulded housing portions 210, 220 that may be pressed or snap fit together once the leash 150 and fluid reservoir 120 have been located in position. As shown in FIGS. 3A and 3B, the housing portion 210 has respective tabs or clips 218 arranged about its periphery that engage with corresponding recesses or grooves 228 in housing portion 220. This facilitates simple assembly of the housing 110. A plurality of guide or locating pins and apertures may further be used to assist in assembly of the housing portions 210, 220.

It is to be appreciated that the internal cavity 104 is formed once the housing portions 210, 220 are mated together. Each housing portion 210, 220 defines a recess 204, 224 that cooperate in use to form the internal cavity 104 in which the fluid reservoir 120 is located. In previous leash assemblies, this space or cavity houses a spool mechanism upon which a retractable leash is wound. By providing a fixed leash, a spool is not required and this space can be used efficiently for housing the fluid reservoir 120. Due to the amount of space available, a reasonably large bottle may be provided that can store a useful amount of water.

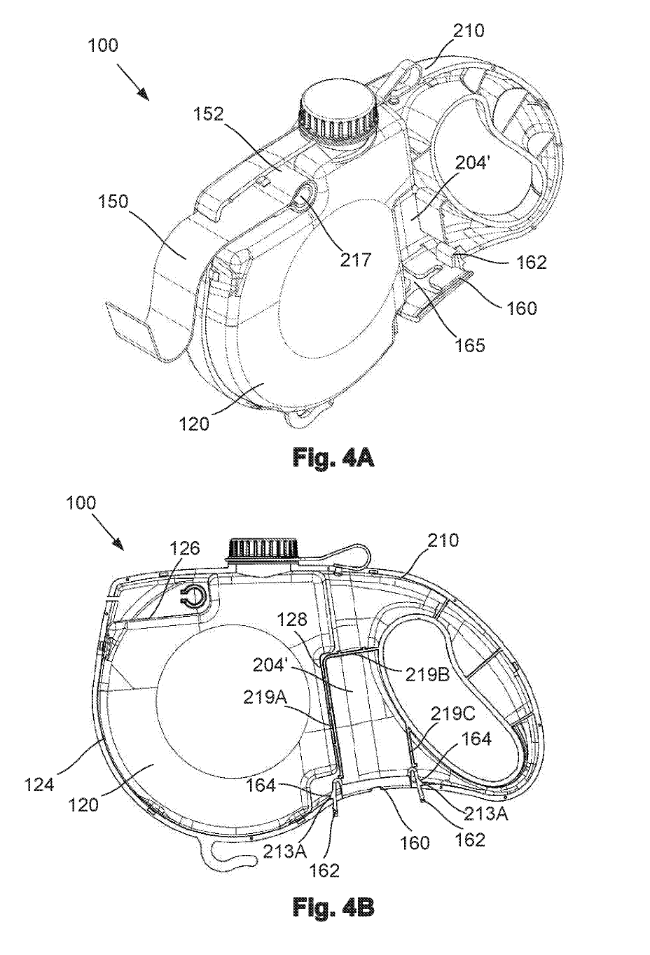

In the example shown, the leash attachment point is a substantially cylindrical or slightly tapered cylindrical protrusion that extends across the housing 110 and which is located in an upper front portion of the housing 110. A first protrusion member 217 projects inward from the first housing portion 210, the first protrusion member having a lengthwise slot 217A that is forwardly disposed with respect to the housing. A second protrusion member 227 extends inward from the second housing portion 220 in a corresponding location, the second protrusion member 227 having a lengthwise rib 227A that is forwardly disposed with respect to the housing. When assembled, the second protrusion member 227 is slidably received in the first protrusion member 217 and the rib 227A is located in the slot 217A. A loop portion 152 of the leash 150 is anchored around the first protrusion member 217 as shown in FIG. 4A to thereby fixedly attach the leash 150 to the housing 110. The leash 150 is then guided through an opening in the housing 110 formed by corresponding slots 211, 221 of the respective housing portions 210, 220.

In order to provide internal storage for the roll of pet waste bags, a storage area defined by spaces 204′, 224′ of each housing portion 210, 220 is formed by partitioning the internal cavity 104. Each housing portion 210, 220 includes a partition portion 219, 229 that in use cooperate to provide a separate internal compartment inside the housing 110 in which the pet waste bags can be located, separate from the fluid reservoir 120. The partition portion 219, 229 of each housing portion 210, 220 may consist of an L-shaped rib that extends upward from the base of the housing and across to the handle structure (216, 226) and a short upright rib spaced apart from the upright section of the L-shaped rib that also extends from the handle structure to the base of the housing. An example of this partition structure is shown for example in FIG. 4B with reference to partition elements 219A, 219B and 219C of the first housing portion 210.

The housing portions 210, 220 further include cut-outs 213, 223 in the base thereof, which cooperate when assembled to define the opening in the bottom of the housing 110 which provides access to the storage area for the waste bags. The cut-outs 213, 223 further include inclined ramp portions such as 213A in FIG. 4B which in use act to catch tab portions 164 that project outward from opposing wings 162 of the removable cover 160 that conceals the storage area. In operation, the cover 160 may be removed by squeezing the opposing wings 162 which urge the tabs 162 off of the ramp sections 213A. A roll of waste bags may then be placed into the storage area defined by the partitions. To dispense the waste bags, a bag may be pulled through an aperture (such as cross-shaped aperture) formed in the cover 160.

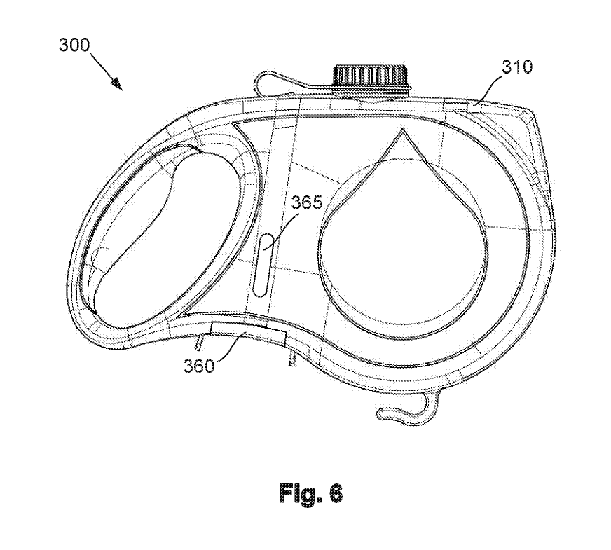

Alternatively, as shown in FIG. 6, a pet leash assembly 300 may be provided in which a waste bag dispensing slot 365 is provided in the side of housing 310, in which case a removable cover 360 may be provided without an aperture such that it functions simply to provide access to the waste bag storage area for loading and removing rolls of waste bags.

After a waste bag has been dispensed and used, it may be hung from hook 170 disposed on the bottom of the housing 110 and comprising first and second complementary hook portions 170A, 170B which come together when the housing portions 210, 220 are assembled to thereby form the hook 170.

Referring again to FIGS. 4A and 4B, the fluid reservoir 120 may be shaped to at least partially conform to the shape of the housing 110 in order to make optimal use of the space provided in the internal cavity 104. In this example, the fluid reservoir 120 includes a curved front edge 124 that conforms to the curvature of a leading edge surface of the housing 110. The fluid reservoir 120 is additionally profiled to fit around the other internal structure of the housing 110. For example, the fluid reservoir 120 may include a recess 126 located in a forward upper portion thereof to accommodate space for the leash attachment point. Further, a rear surface 128 of the fluid reservoir 120 is typically shaped around at least part of the partition which defines the storage area for the waste bags.

The inlet 122 of the fluid reservoir 120 is typically at least partially threaded and adapted to extend at least partially through the opening 122 in the upper surface of the housing 110 that is defined by opening portions 212, 222 of each housing portion 210, 220. The cap 130 is screwed onto the inlet 122 and operable by a user to remove in order to allow fluid to be dispensed. A strap 135 may be coupled between the cap 130 and the housing 110 in order to secure the cap 130 thereto.

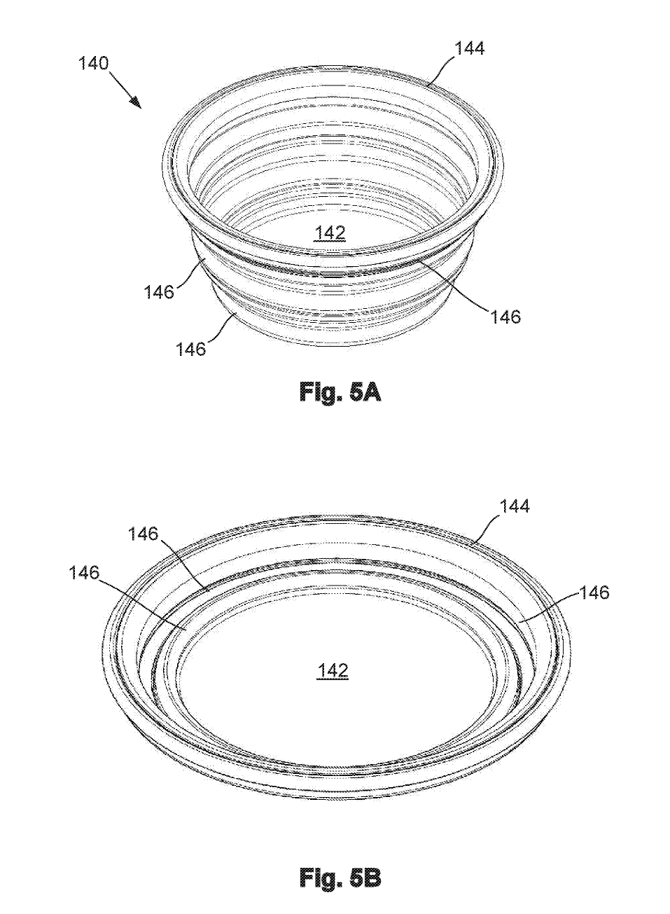

The collapsible bowl 140 is shown in a deployed and a collapsed configuration in FIGS. 5A and 5B respectively. The bowl 140, which is typically made from a food grade silicon or polypropylene, generally includes a base 142, a rim 144 and a sidewall extending between the base 142 and rim 144 comprising a plurality of collapsible sections 146 that allow the sidewall to fold in a concertina manner into a very compact configuration for mounting to the assembly 100. In this regard, the bowl 140 is designed to be secured to one side of the housing 110 by a plurality of clips 225 that project outward from housing portion 220 and which act to restrain the bowl 140 in the collapsed configuration.

Accordingly, it will be appreciated that in at least one example the above described pet leash assembly is a multi-functional apparatus that enables a user to compactly and conveniently carry a range of supplies including a water bottle for use while out on a walk or away from home. The ability to nest a bottle within the housing of the leash assembly in the manner provided enables a useful quantity of fluid such as water to be carried. Furthermore, the bottle can be accessed to dispense fluid in a simple manner without requiring any part of the assembly to be disassembled in order to access the bottle. The integration of the water bottle into the housing as described effectively enables the leash assembly to function as a bottle. By providing a collapsible bowl, the water bottle can be used more widely in situations where the pet prefers to drink from a bowl instead of directly from a bottle. The further integration of storage for a roll of waste bags, and a hook for carrying a used waste bag provides the user with a convenient way of handling the task of waste collection and disposal.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A pet leash assembly, including:
a) a housing configured to provide:
i) a handle;
ii) an internal cavity; and,
iii) an opening leading into the internal cavity;
b) a fluid reservoir having a hollow body positioned within the internal cavity of the housing, the fluid reservoir including a fluid inlet arranged to extend at least partially through the opening to enable the body to be filled and/or emptied via the fluid inlet; and,
c) a leash coupled to the housing.

2) The pet leash assembly according to claim 1, wherein the body has a height that substantially corresponds to a height of the housing.

3) The pet leash assembly according to claim 1, wherein a ratio between a length of the housing and a length of the body is in a range of 3:1 to 1.5:1.

4) The pet leash assembly according to claim 1, wherein at least one of:
a) the body is positioned at least partially in abutment with a leading edge surface of the housing; and,
b) the body includes a curved outer surface portion that substantially conforms to a curvature of the housing.

5) The pet leash assembly according to claim 1, wherein the housing further provides a fixed attachment point for the leash.

6) The pet leash assembly according to claim 5, wherein the attachment point is located within the internal cavity.

7) The pet leash assembly according to claim 6, wherein the attachment point is a protrusion that extends substantially across the housing and wherein the body of the fluid reservoir is shaped to accommodate the positioning of the attachment point within the internal cavity.

8) The pet leash assembly according to claim 7, wherein the leash is looped around the attachment point and fed through a leash aperture in the housing.

9) The pet leash assembly according to claim 1, wherein the fluid reservoir further includes a cap for covering the fluid inlet, the cap in use disposed above a top surface of the housing.

10) The pet leash assembly according to claim 9, wherein the cap is tethered to the housing by a strap.

11) The pet leash assembly according to claim 1, wherein the internal cavity includes at least one partition that in use defines an internal storage area between the handle and the fluid reservoir.

12) The pet leash assembly according to claim 11, wherein the internal storage area is used for storing pet waste bags.

13) The pet leash assembly according to claim 12, wherein the internal storage area is accessible from a bottom surface of the housing.

14) The pet leash assembly according to claim 13, wherein the internal storage area is covered by a removable cover and wherein at least one of:
a) the removable cover includes an opening through which waste bags can be dispensed; and,
b) the housing includes a slot in a side portion thereof for dispensing the waste bags.

15) The pet leash assembly according to claim 14, wherein the removable cover includes a pair of resiliently deformable wings that releasably latch to the housing.

16) The pet leash assembly according to claim 15, wherein a portion of the wings project below the housing and are responsive to a squeezing pressure to unlatch the cover.

17) The pet leash assembly according to claim 1, further including a hook attached to or integral with the housing for hanging used waste bags.

18) The pet leash assembly according to claim 17, wherein the hook is disposed beneath the housing.

19) The pet leash assembly according to claim 1, wherein a collapsible bowl is releasably mounted to one side of the housing.

20) The pet leash assembly according to claim 19, wherein the housing includes a plurality of resiliently deformable clips that project outward from the side of the housing for releasably securing the collapsible bowl thereto.
